(19) United States
(12) Patent Application Publication
(10) Pub. No.: US 2003/0063302 A1
(43) Pub. Date: Apr. 3, 2003

(54) Testing means and process for controlling offset and digital printing

(76) Inventors: Kurt Munger, Gossau (CH); Markus Dattwiler, Gallen (CH); Karl Heuberger, Gallen (CH); Herbert Janser, Bolligen (CH)

Correspondence Address: MCGLEW & TUTTLE, PC, SCARBOROUGH STATION, SCARBOROUGH, NY, 10510, US

(21) Appl. No.: 10/235,970

(22) Filed: Sep. 5, 2002

(30) Foreign Application Priority Data
Sep. 7, 2001 (DE) P 101 43 942.3

(51) Int. Cl. B41J 1/00; G06F 15/00

(52) U.S. Cl. 358/1.9

(57) ABSTRACT

A new testing means and process for determining typographic parameters were developed. The present invention pertains to a pattern of recorded dots, so-called dots, which is reduced such that it is nearly invisible to the observer. This test target is microscopically enlarged and preferably recorded by means of a CCD camera. The signal-to-noise ratio of the measurement is advantageously increased by averaging over a plurality of consecutive printed patterns. Using highly developed image analysis, it is possible to determine the typographic parameters directly from the miniaturized patterns. The measures taken to reduce the test target are described. The application to the type of a process control, which is based essentially on the geometric features of a certain dot pattern, is then schematically outlined as an example.

### FIELD OF THE INVENTION

Conventional print control strips are normally designed for densitometric or visual testing. Print control strips are divided into test elements, which permit the individual functions of the printing process to be tested. This results in control strips of a considerable size, typically 12 mm×150 mm. This type of control strip is not generally applicable to process controls, especially if there is no place for positioning. The use of the conventional control means is likewise limited when cutting away is not possible after the printing and the control means is thus visible on viewing as a disturbing formation.

### BACKGROUND OF THE INVENTION

In principle, there are two promising processes to eliminate this problem, measurements in the image and miniaturization of the control strip.

Measurements in the image, which are related to the original image data, are preferably used to assess the quality of the print result. Contrary to this, controls based on test elements provide information on the printing process. The current state of the art is reviewed in the IFRA Report (Ifra, 2001).

The MiniTarget measuring system described by Künzli et al. adopts the second process (Künzli, 1998). It represents a major step in the direction of the miniaturization of quality control means. With its dimensions of 7 mm×10 mm, it is possible to record the entire image information of the MiniTarget with a CCD camera and to derive therefrom the typographic parameters by calculation. In the essential forms, the MiniTarget concept is understood to be a continuation of an idea that is already used in the conventional print control strips. In particular, it has a design analogous to that of print control strips, which are arranged as strips having a small area. With the existing dimensions, the MiniTarget continues to be disturbing in appearance to the reader. A size that is significantly below 1 mm² is required to be invisible or, more correctly, “imperceptible.”

### SUMMARY OF THE INVENTION

This problem requires a further miniaturization of the test target to an extent that it is at least not obviously perceived. A new methodological approach is necessary for this.

The image analysis was hitherto used especially for integral area measurements of half-tones. However, this application is far from exhausting the potential of image analysis for the quality and process control. Locally resolving image analysis combined with highly developed analysis of the data is the key to two processes, which differ fundamentally from the integral measurement method such as densitometry and spectrophotometry:

Pattern recognition: It creates the prerequisites for the determination of dot cluster positions and for the adaptation of the measuring diaphragm to the dot pattern of the measured sample,

characterization of dot clusters: It is thus possible to derive the typographic parameters from dot clusters instead of from half-tone areas.

A novel testing means and process for determining typographic parameters were developed. The present invention pertains to a pattern of recorded dots, such as lines and areas with square or round limitations, which is reduced such that it is already invisible or nearly invisible to the observer as part of a printed image.

This test target is microscopically enlarged and preferably detected by means of a CCD camera. The signal-to-noise ratio of the measurement is advantageously increased by averaging over several consecutive print patterns. Using highly developed image analysis, it is possible to determine the typographic parameters directly from the miniaturized patterns. The measures taken to reduce the test target are described. The application to the type of a process control, which is based essentially on the geometric features of a certain dot pattern, is then outlined as an example.

The dot pattern or the TestTarget (test target) is so small that it is practically no longer perceptible to the naked eyes of the observer. The dot pattern is formed by a plurality of dot clusters in a typical arrangement, preferably without dot closure of the dot clusters among each other. The arrangement of the dot clusters is typical in the sense that the dot pattern as such is identifiable in the printed copy. The arrangement of the dot clusters in the TestTarget, i.e., the dot pattern, is preferably periodic. The TestTarget has an overall area, i.e., an area of the dot clusters + area of the intermediate spaces, of at most one square mm and is preferably square. Its area is preferably smaller than 0.5 mm². The data presented concerning the size of the area advantageously also apply when a virtual frame is drawn around the entirety of the dot clusters of the TestTarget, i.e., the size indicated applies to the area within the frame. Each of the dot clusters is preferably printed with exactly one print color and is preferably formed by at least two recorded dots in the X direction and two recorded dots in the Y direction, i.e., by preferably at least four recorded dots, which are directly adjacent to one another in the X and Y directions of the circumferential and lateral directions. The printed pixel can be considered to be a recorded dot in the sense of the greatest possible miniaturization.

Using a highly developed image analysis, both the density, the color location and the surface coverage of each of the individual colors of the dot cluster as well as the register mark in multicolor printing can be determined from the test target. In addition, reliable diagnosis in respect to shifting and doubling is also made possible. The dot pattern can also be used, moreover, for controlling the gray balance in multicolor printing.

The dot clusters are at least so large that they can be evaluated planimetrically. The evaluation is advantageously performed in the printing press during printing.

To determine color densities and color locations in the case of the overprinting of a plurality of colors, the test target according to the present invention (dot pattern) can be complemented with a supplementary test target (trapping pattern). The supplementary target preferably has the same size and shape as the test target based on the dot pattern. Depending on the sequence of colors, the supplementary test target may contain the following color fields in multicolor printing: C/M, C/Y, M/Y and C/M/Y (C=cyan, M=magenta, Y=yellow). The trapping pattern may be placed either side to side to the dot pattern or also independently therefrom on the side of the printed copy.

The present invention can be used advantageously in offset printing, especially in wet offset printing. An especially preferred field of application is newspaper printing on web-fed rotary printing presses. A test target according to the present invention can be advantageously printed along in the image or in image-free areas, especially on a lateral edge, of a printed copy of the newspaper edition. The present invention offers the greatest advantages in multicolor printing, even though it may also be advantageously used in one-color printing.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is an arrangement of the dot clusters C, M, Y and K for a test target based on a specific dot pattern;

FIG. 1b is a representation of the arrangement of FIG. 1a for p=q=2 in a square grid;

FIG. 1c is a printed example of the pattern according to FIG. 1b;

FIG. 2a is a three-dimensional plotting of a dot cluster before the averaging.

FIG. 2b is a three-dimensional plotting of a dot cluster after the averaging.

FIGS. 3a is a half-tone image of dot clusters before a threshold value process;

FIGS. 3b is a half-tone image of dot clusters after a threshold value process;

FIG. 4a is a view of a computer simulation of the pattern of round dot clusters;

FIG. 4b is a view of a computer simulation of the shifting effect; and

FIG. 4a is a view of a computer simulation of the doubling effect.

### DESCRIPTION OF THE PREFERRED EMBODIMENTS

### Design of Dot Patterns

Referring to the drawings in particular, a preferred design of a dot pattern will be explained below based on the example of four-color printing and with reference to the above-mentioned aspects.

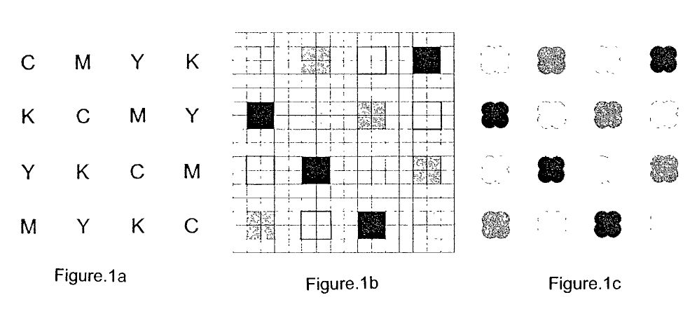

The test target is based, as is shown in FIG. 1, on a specific dot pattern. Specifications of the dot pattern in the “invisible test target” or imperceptible test target are as follows:

a) Arrangement of the dot clusters C, M, Y and K as shown in FIG. 1 a;

b) representation of a) for p=q=2 in the square grid as shown in FIG. 1b; and

c) a printed example of the pattern according to b) as shown in FIG. 1c.

C, M, Y and K in FIG. 1 a symbolize clusters of recorded dots in the corresponding colors. n is the total number of dot clusters in the horizontal and vertical directions, respectively. The clusters are preferably built up of an equal number, i.e., 1×1, 2×2, 3×3, . . ., p×p adjacent recorded dots in the x and y directions. The dot size corresponds to the addressability of the output device, which is expressed in dpi (dots per inch). The unprinted intermediate space in the test target is q pixels in both the x direction and in the y direction.

FIG. 1b shows as an example the embodiment of 1a for the parameters n=4, p=2 and q=2. The dot clusters are designated in matrix notation by elements with the subscripts (i,j).

The dot pattern shown for the case of four-color printing can be extrapolated to multicolor printing. The colors are preferably arranged such that the dot clusters extending diagonally from top left to bottom right have equal color and all primary colors are arranged one after another in the topmost line.

A fictitious frame is preferably defined for test targets based on dot patterns in such a way that a cell with a periodic regularity will result. This measure is taken concerning the evaluation, which shall not depend on the positioning of a measuring diaphragm. This subject will be discussed later.

The control process is characterized in that both the deviations from the register mark and the typographic parameters can be determined from the test patterns described in FIGS. 1a to 1c based on an example. It is mentioned, in particular, that not only shifting, doubling and surface coverage can be determined by means of a locally resolving image analysis evaluation, but characteristics based on dot clusters, which are not accessible in conventional densitometry or spectrophotometry, can also be determined.

The type of dot clusters presented is characterized by another remarkable property. The dot patterns correspond to small-area half-tone dots, which contain characteristic information of the printing process. As is shown in FIGS. 1a to 1c, small-area dot clusters respond to process-related deviations of the print significantly more sensitively than half-tone dots in conventional control strips or in the MiniTarget. The most important influential factor is the increase in tone value, which is manifested in dots being usually reproduced too large compared with the theoretical area coverage. The effect is visualized in FIG. 1b/c. The increase in tone value increases the size of the dot by a fixed amount, which does not depend on the dot diameter. As a consequence, the effect increases in inverse proportion to the dot radius. The type of dot patterns as shown in FIG. 1 consequently responds to variations of the process particularly sensitively.

The side length of the test target in FIG. 1b is calculated as follows:

$$side length ( in μm ) = \frac{25 , 400 μm}{dpi} ( n * p + ( n - 1 ) q ) \qquad \text{(1a)}$$

The percentage dot area A equals

$$A ( in \% ) = \frac{{p}^{2}}{{( p + q )}^{2}} * 100 \% \qquad \text{(1b)}$$

Typical values for A are 25% with p=q, 16% with p=2 and q=3, and 11.1% with p=2 and q=4.

For the dot pattern in FIG. 1b, the side length is 635 dpi, output 0.56 mm. The area is 0.31 mm². This is more than 100 times smaller than the MiniTarget according to Künzli, 1998.

A supplementary test target was developed especially for densitometry and colorimetry. This test target preferably has the same size and shape as the target based on a dot pattern. In the case of four-color printing, it is divided into four quadrants, which contain color fields printed one over another. In the case of four-color printing, these are, e.g., C/M, C/Y, M/Y and C/M/Y, depending on the sequence of the colors. The target may be placed side to side to the target based on a dot pattern or also independently therefrom. It is used especially to determine the color densities in overprinting and the ink uptake. A process described in (Künzli, 2000) is used for this.

Attention must be paid to the selection of the parameters in Equation (1a/b) in the concept of the “Invisible test target” or imperceptible test target . n should be selected to be low in regard to the requirement that the test target should have a small area. On the other hand, it is to be ensured that the printed dot clusters are representative of the printing process. Attention should be paid especially to the increase in the tone value when setting p and q. Dot clusters of the same color should be prevented from touching each other on the sample, because the evaluation by image analysis can no longer be performed in a dot cluster-specific manner in this case, or it becomes at least considerably more difficult. A test pattern with 16% or 11.1% of area coverage instead of 25% area coverage may be advantageous for this reason.

Preparation of the Measuring Samples

Four samples were prepared for the investigations. The dot patterns were programmed in the PostScript programming language. The specifications are listed in Table 1.

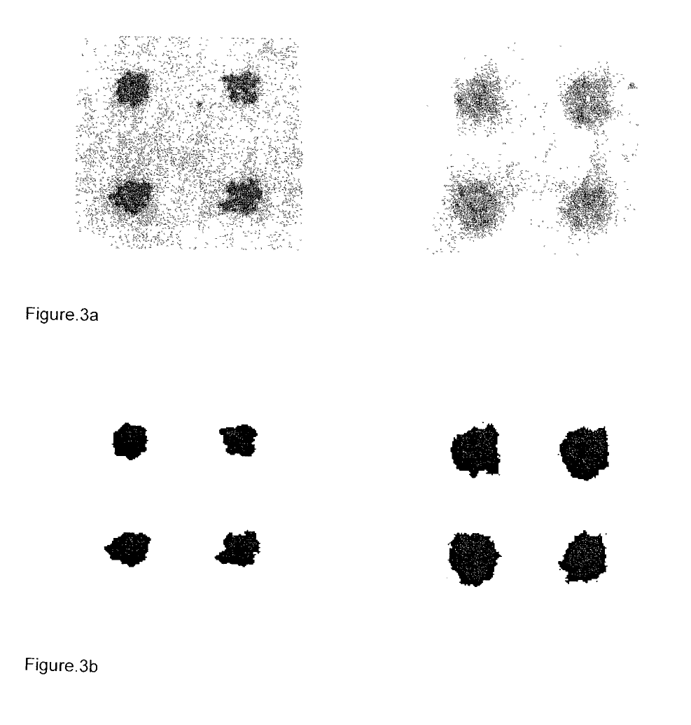

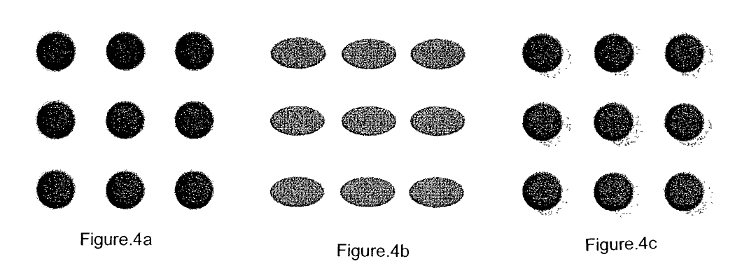

TABLE 1
Review of the specifications of the samples.

| Sample No.: Production | Substrate | Dot pattern |
|---|---|---|
| No. 1: Electrophotographic | Coated paper | p = 2, q = 2 |
| printer (CMYK, 400 dpi) | | |
| No. 2: Electrophotographic | Recycled paper | p = 1, q = 2 (A = 11.1%) |
| printer (single color, | | (cf. FIG. 3) |
| 600 dpi) | | |
| No. 3: Newspaper printing | Newsprint | p = 4, q = 8 (A = 11.1%) |
| (single color, 1,200 dpi) | | (cf. FIG. 3) |
| No. 4: Computer simulation | | Dot pattern for the |
| | | evaluation of shifting |
| | | shifting/doubling |
| | | (cf. FIG. 4) |

Measuring Means

The components of an image analysis system preferably include a 3-CCD camera, a microscope, a Framegrabber card and an image analysis software. During the measurement, it must be ensured, in particular, by the correct setting of the microscope, the lighting and the camera that a stable image rich in contrast will be obtained. Excessive amplification of the measured signal results in intense noise of the image.

A spectrophotometer operating according to the spectral method may also be used instead of a camera operating according to the three-range method to determine tristimulus values.

In addition, both the size of the measuring diaphragm and its positioning on the sample to be measured are critical. If the measuring diaphragm is set to a low value, only a small number of dot clusters will be detected. It is consequently necessary to accept the risk that the random sample will not be representative, i.e., the dot clusters of different colors will not be taken into account corresponding to the percentage at which they occur in the measured sample. This results in a systematic error of measurement (Romano, 1999). This is especially great when the ratio of the size of the measuring diaphragm to the dot cluster period has a low value and is between two consecutive integers, i.e., e.g., 1.5. The image section detected is therefore adapted by means of the software to the fictitious image frame, which is an integer multiple of one period. As a result, parameters are obtained that are independent from the setting of the measuring diaphragm. A single dot cluster per print color is basically sufficient for characterizing the printing process. However, it is recommended for reasons of the sample preparation and the measurement technique to provide at least four dot clusters per print color for the measurement.

The two test fields presented are suitable for performing color and density measurements despite the extremely small dimensions. The measurement of the full-tone density and the tristimulus values of the individual colors is performed on dot clusters. The supplementary test field based on color fields, which was described farther above, is used for the measurements of overprinted colors. This requires the calculation of the ranges of measurement by means of software. Calibration of the 3 chip CCD camera is necessary for the measurements (Künzli, 2000).

Methods

The evaluation of the digitized images is performed by means of image analysis (Demant Ch., 1998; Jähne B., 1997). The image analysis is based on the RGB image, which is represented with a sufficiently high resolution. The diameter of a dot cluster should be recorded by at least 30 pixels. Most of the measurements are performed separately for each print color. The channel with the color that is complementary to the observed print color is evaluated in this case. The setting of the threshold value is a fundamental image analysis process to distinguish the dot clusters from the whiteness of the paper (Barratte Ch., 1995). The signals from the whiteness of the paper and from the print colors are determined in the half-tone histogram of the half-tone image. The arithmetic mean of the modal values of the whiteness of the paper and the print color is used as the threshold value by removing small-area shapes outside the dot cluster positions by image analysis.

A preferred evaluation takes place as follows:

Calculation of the centers for all dot clusters as an arithmetic mean from the x and y coordinates of the pixels belonging to the dot clusters;

Division of the dot pattern into dot clusters with periodic regularity as, e.g., in FIG. 1, and subsequent calculation of the register mark deviations;

Determination of the parameters of the dot clusters, especially area, shape (elliptical or round), the uniformity of the edge;

Calculation of the shifting and doubling.

Averaging of the Signals

Conventional print control strips are characterized in that the typographic parameters can be taken from the test elements with sufficient accuracy. Contrary to this, miniaturized control means are subject to limitations in this respect, because the area of the sample contains only a small number of dot clusters. These dot clusters are subject to random variations, which are due to typographic factors and factors related to the material. To a low extent, random variations stem from the optical measurement process. These difficulties can be eliminated for the most part by signal averaging.

Averaging over N signals increases the signal-to-noise ratio by the factor N (Bovik, 2000). Two different types, which pursue different goals, are considered in connection with this investigation:

Determination of the properties of an individual dot cluster with high accuracy;

Determination of the average geometry of dot clusters.

To determine the properties of an individual dot cluster with high accuracy, the measurement process is repeated with constant settings. It is assumed in this connection that the noise components of the signals have a gaussian distribution (Al Bovik, 2000). The averaging is performed according to Equation 2a. It was found that this type of averaging is not relevant, because the signal-to-noise ratio is sufficient.

$$I ( x , y ) = \frac{1}{N} {\sum }_{i = 1}^{N} {I}_{i} ( x , y ) i = {i}^{t h} m e a s u r e m e n t \qquad \text{(2a)}$$

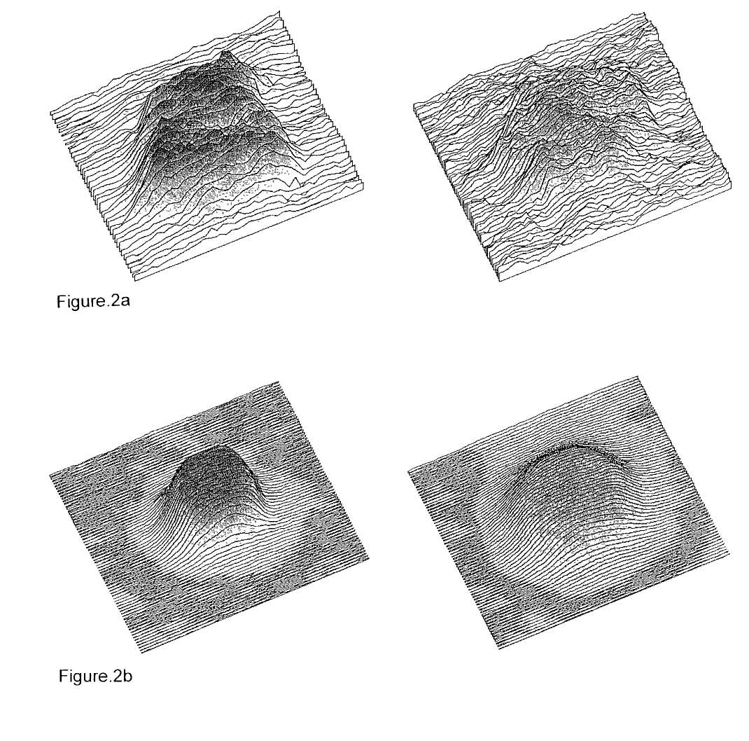

In the second case, signals of different dot clusters are used in order to calculate the average geometry S(x,y) of a dot cluster (Equation 2b). To do so, the light intensities I of N different dot clusters are determined from test patterns of the same or consecutive prints. The signals are then logarithmized. The fact that the optical density is correlated with the thickness of the ink layer is taken into account herewith. Finally, the images of the N dot clusters with common center are superimposed and divided by N. This results in an image that represents the average geometry of dot clusters (FIG. 2).

$$S ( x , y ) ∝ \frac{1}{N} {\sum }_{i = 1}^{N} log ( I ( {x}_{i} + x , {y}_{i} + y ) ) i = {i}^{t h} do t c l u s t e r \qquad \text{(2b)}$$

[(xᵢ,yᵢ: Center of the i^{th} Dot Cluster, (x,y)εArea of the Dot Cluster]

The physical meaning of the first averaging process is obvious, whereas the physical meaning of the second averaging process must be commented on. An average geometry of a dot cluster calculated in this manner does not exist in the real world. However, the forms of the average geometry contain features specific of the printing process, which are not visible on the individual dot cluster because of irregularities of the materials used and the reproduction. Process parameters can be analogously obtained by the statistical treatment of the numeric data of all N dot clusters (Table 2). Agreement can be expected between the parameters measured on the averaged dot and the mean values of the parameters measured on the individual dot clusters in the case of the area, the shape, the density and the color values.

Register Mark Deviations

The centers of the individual dot patterns are calculated for C, M, Y and K according to Equations (3a-d) for the test target in FIG. 1b. Here, (i,j) designate the center of the dot cluster in matrix notation in reference to FIG. 1b.

X-Cyan=0.25(X-Cyan(,1)+X-Cyan(2,2)+X-Cyan(3,3)+X-Cyan(4,4))

Y-Cyan=0.25(Y-Cyan(1,1)+Y-Cyan(2,2)+Y-Cyan(3,3)+Y-Cyan(4,4)) (3a)

X-Magenta=0.25(X-Magenta(1,2)+X-Magenta(2,3)+X-Magenta(3,4)+X-Magenta(4,1))

Y-Magenta=0.25(Y-Magenta(1,2)+Y-Magenta(2,3)+Y-Magenta(3,4)+Y-Magenta(4,1)) (3b)

X-Yellow=0.25(X-Yellow(1,3)+X-Yellow(2,4)+X-Yellow(3,1)+X-Yellow(4,2))

Y-Yellow=0.25(Y-Yellow(1,3)+Y-Yellow(2,4)+Y-Yellow(3,1)+Y-Yellow(4,2))

X-Black=0.25(X-Black(1,4)+X-Black(2,1)+X-Black(3,2)+X-Black(4,3))

Y-Black=0.25(Y-Black(1,4)+Y-Black(2,1)+Y-Black(3,2)+Y-Black(4,3)) (3d)

Finally, the register mark deviations DX and DY are calculated according to Equations (3e-g), taking black as the reference.

DX(Cyan/Black)=X-Cyan-X-Black

DY(Cyan/Black)=Y-Cyan-Y-Black (3e)

DX(Magenta/Black)=X-Magenta-X-Black

DY(Magenta/Black)=Y-Magenta-Y-Black (3f)

DX(Yellow/Black)=X-Yellow-X-Black

DY(Yellow/Black)=Y-Yellow-Y-Black (eg)

The absolute values of the register mark deviations are obtained from the distance measures in the dot cluster patterns of the same colors, which are defined in dpi units of the output device.

Determination of Characteristic Variables of the Dot Clusters

Some parameters can be determined directly from the half-tone images of the dot patterns in FIG. 3a. The half-tone image is converted here by the threshold value method into a binary representation in order to separate the dot clusters from the whiteness of the paper.

The percentage area coverage is a decisive factor in the printing process. Contrary to the conventional densitometry, the image analytical area measurement is based on the principle of planimetry. The areas of the dot clusters are first determined individually. The dot cluster areas are then added up for all colors and divided by the area of the fictitious measuring diaphragm. The resulting value corresponds to the percentage area coverage.

The following parameters are preferably determined from the geometric areas of the dot clusters:

Size of the dot cluster;

largest/smallest diameter of the dot cluster;

position angle (α).

Additional parameters are calculated from the above characteristics for the dot clusters.

Parameter E describes the geometry of the dot cluster with respect to an elliptical shape. This parameter will be used below in order to determine the shifting and doubling.

$$E ( in \% ) = ( \frac{smallest diameter}{largest diameter} ) * 100 \% \qquad ( 4 )$$

Depending on the resulting value of E, the dot cluster tends to have a circular shape (E=1), an elliptical shape (E within 0% and 100%) or to be a straight line (E=0%).

The so-called factor R is an indicator of the smoothness of the shape of the edge of dot clusters (Haberacker, 1995), which is a characteristic variable of the printing process. R is the ratio of the area of the dot cluster to the second power of the size (Equation 5):

$$R = ( \frac{4 π * m e a s u r e d a r e a}{s i z e o f t h e d o t c l u s t e {r}^{2}} ) \qquad ( 5 )$$

Depending on the resulting value of R, the shape of the edge is classified as being smooth (R=1), frayed (R within 0 and 1) or fractal (R=0).

Process Parameters with Diagnostic Function

Shifting and doubling are two typical effects in the printing process, which point to a disturbance in the way the process is conducted (Romano F., 1998). Shifting may be caused by different speeds of rotation of the two cylinders and is manifested in broadened lines across the direction of printing. The effect is manifested visually in vertically extending lines, which are broadened and therefore appear to be darker.

Doubling is caused by register problems between different printing mechanisms of multicolor printing presses and is manifested in a lateral offset of the dot and the appearance of the dot once again in a weakened form. The effect is recognized visually from line fields appearing darker in one direction as a consequence of the broadening. Contrary to shifting, doubling may occur in any orientation.

Both types of deviation are determined visually or by measurement on the basis of shifting or doubling fields. FIG. 4 shows a computer simulation of the effect.

Both effects can be derived by image analysis methods from the dot pattern which was already used for the measurement of the register mark and the color.

The presence of shifting is derived, corresponding to Equation (4) from the factor E in conjunction with the position angle of the dot cluster. Related trends become visible from the statistical treatment. A preferential direction is proved if the standard deviation of the angle is sufficiently small.

Doubling is manifested in the histogram of the half-tones. This shows essentially two signals, which originate from the whiteness of the paper and the printed dot clusters. The signal of the dot clusters is slightly broadened or even shows a side maximum in the case of doubling. The extent of doubling is determined according to the following steps:

Transformation of the original half-tone image by means of the threshold value method into a binary image. The threshold value is set such that a broadening of the dot caused by doubling is included. The coordinates (x,y)−2 of the centers of the dot clusters are then calculated.

Transformation of the original half-tone image by means of the threshold value method into a binary image. The threshold value is set such that a broadening of the dot caused by doubling is not included. The coordinates (x,y)−1 of the centers of the dot clusters are then calculated.

The doubling effect D is obtained from the difference of the two vectors according to Equation 6:

D=(x,y)−2−(x,y)−1

Results and Discussion

The methods described above were tested experimentally. The samples 1-4 in Table 1 were used for this purpose. The test results obtained for samples 1 and 2 are shown in Table 2.

TABLE 2
Results of the image analysis compared with the specified
values of a single-color test pattern, which was prepared on an
electrophotographic printer and in newspaper printing. Notation
in ” (s).

| Electrophotography | Image analysis | | Specification |
|---|---|---|---|
| Absolute area of dot cluster | 1,416 | (127) | 1,792 |
| (in μm²) | | | |
| Area coverage of dot cluster in % | 8.7 | (0.8) | 11.1 |
| Size of dot cluster (in μm) | 159 | (14) | 169 |
| Diameter of smallest/largest dot | 39/46 | (3/2) | 42.3/42.3 |
| cluster (in μm) | | | |
| Angle in degrees | 73 | (59) | |
| Ellipsoid factor E in % | 87 | (4) | Equation (4) |
| Edge smoothness R in % | 0.72 | (0.04) | Equation (5) |
| Newspaper printing | | | |
| Absolute area of dot cluster | 10,769 | (990) | 7,174 |
| (in μm²) | | | |
| Area coverage of dot cluster in % | 16.8 | (1.5) | 11.1 |
| Size of dot cluster in (in μm) | 458 | (33) | 339 |
| Diameter of smallest/largest dot | 110/124 | (6/7) | 84.7 |
| cluster (in μm) | | | |
| Angle in degrees | 71 | (50) | |
| Ellipsoid factor E in % | 88 | (2) | Equation (4) |
| Edge smoothness R in % | 0.65 | (0.06) | Equation (5) |

Representative results of the image analysis are shown in FIGS. 2a, 2b and 3a, 3b. FIG. 2a shows a relief view of a dot cluster printed electrographically (left: 126 μm·126 μm) (right: 250 μm·250 μm). The vertical axis shows half-tones. FIG. 2b shows a relief view of averaged dot clusters: printed electrographically (left: size of sample 36, 126 μm·126 μm) and in newspaper printing (right: size of sample: 41, 250 μm·250 μm). The vertical axis shows half-tones. FIGS. 3a and 3b show half-tone images of dot clusters before and after the threshold value process. FIG. 3a shows Half-tone images of four dot clusters, printed electrographically (left: 250 μm·250 μm) and in newspaper printing (right: 500 μm·500 μm). FIG. 3b shows binary images after the threshold value formation of the half-tone images in FIG. 3a.

The area coverage of the test pattern of sample 1 equals 8.7%. The size of the random sample equals 36 dot clusters. The standard deviation of 0.8% results from random variations in the process and material, which lead to dot clusters of different sizes. Preliminary measurements show that densitometric area measurements generally yield higher values. This is explained by the optical light gathering, which is not taken into consideration in the image analysis. Moreover, it was observed that the accuracy of the measurements depends substantially on the lighting as well as on the selection of the threshold value. Attention should therefore be paid especially to reproducible measurement conditions. The following parameters pertain to geometric dot clusters and parameters that are obtained numerically from the areas of the dot clusters. The size of the dot is 159 μm, which is somewhat smaller than the specified value of 169 μm based on the lower area coverage. The ellipsoid factor E equals 87%, from which a roundish geometry is inferred. This finding is confirmed from the averaged structure in FIG. 2. This will then also explain the great dispersion of the angle and why no preferential direction can be recognized. The mean value equals 73° and has a standard deviation of 59°. The factor R, equaling 0.72, shows a nonuniform edge structure. This finding agrees visually with the relief view in FIG. 2a and the half-tone images in FIG. 3. The results of the newspaper print patterns show a behavior similar to that of sample 1.

Densitometric and colorimetric measurements may likewise be performed on the test pattern in FIG. 1. The image analysis system is first calibrated according to a method that is described in the literature (Künzli, 1998). It makes possible the conversion of RGB values into colorimetric and density values. Diaphragms that selectively record the dot clusters are determined for the measurements by calculation.

The averaging of signals was investigated on the printed pattern prepared electrophotographically (sample 2) and by newspaper printing (sample 3). The dot clusters are shown in FIG. 2 before and after the averaging. It is obvious that the averaged structures have smoother shapes than the structures of individual dots. The averaged structures in FIG. 2 make it possible to recognize that the dot clusters prepared electrophotographically tend to have a square structure. Contrary to this, the dot clusters in the newspaper print have a roundish shape. It appears from the comparison of the results in Table 2 that the characteristics of the dot clusters calculated from the individual values are in good agreement with the characteristics that were determined from the averaged structures. This is true of the absolute areas, the percentage area coverage, the ellipsoid factor E and the largest and smallest diameters. In the case of the edge smoothness R, 0.92 is obtained for the averaged structures in the newspaper print and 0.91 for electrophotography. As was expected, these values are markedly higher than the corresponding mean values of 0.65 and 0.72 in Table 2. This difference is due to the smoothing effect, which arises from the averaging.

The register mark differences were determined according to Equations (3a-g) from the test pattern of the color printer (sample 1). Deviations between 15 μm and 55 μm were obtained. This value is below the specified diameter of the dot cluster, which equals 63 μm. The values determined are within the tolerances of offset printing, which are specified in ISO 12647-2 as 83.3 μm for 60 l/cm. On the whole, the results show that the analysis of the register mark deviations can be performed on a test pattern that does not appear conspicuously.

FIG. 4 shows the computer simulation of the shifting and doubling for an evaluation of shifting and doubling (computer simulation) with

a) Pattern of round dot clusters;

b) Shifting;

c) Doubling;

The analysis of shifting was performed on a sample that was prepared by computer simulation (cf. FIG. 4b). The evaluation is based on the ellipsoid factor E in Equation 4. The smallest and largest diameters were found to be 1.72 and 1.77 relative units, and the angle was found to be 172°. These values are in good agreement with the input values of the computer simulation. Shifting is thus quantitatively demonstrated. The analysis of doubling in FIG. 4c is performed according to Equation 6. The resulting vector difference is calculated as distance and angle relative to the coordinates of the center of the dot cluster without doubling. A distance of 0.18 relative units and an angle of 145° are obtained. Slight variations of these values are attributed to digital noise, which was introduced during the modeling.

Conclusions and Prospects

This study shows that the newly developed test pattern or test target can be used for controlling the multicolor printing in conjunction with the evaluation method described. The process is indicated especially where process control is necessary, but no control strips can be used because of insufficient space. Nearly unlimited use is possible with a test pattern area that is markedly smaller than 1 mm². In particular, specific positioning close to selected image areas can now be performed. The limits of what is feasible were consequently explored with the process described. These explorations culminate in the observation that the typographically relevant parameters can be ultimately obtained from a test pattern, which is built up from one dot cluster per print color. However, averaging over several print patterns printed consecutively is advantageous. All the measures described, which in their entirety make possible such a miniaturization of the test target, were tested experimentally or by simulation.

Extrapolation of the results over the entire range of the color value curve is promising with the use of prediction methods as they are currently being developed by EMPA, St. Gallen, Switzerland (Mourad, 2001).

While specific embodiments of the invention have been shown and described in detail to illustrate the application of the principles of the invention, it will be understood that the invention may be embodied otherwise without departing from such principles.

### APPENDIX

### LIST OF REFERENCES

1. Barratte Ch., Dalphond J. E., Mangin P. J. and Valade J. L. (1995), An Automatic Determination of Threshold for the Image Analysis of Prints. Proceedings of the 23^{rd} Research Conference of IARIGAL, Paris, 451-469.

2. Bovik Alan C., (2000), Handbook of Image and Video Processing, Academic Press, New York.

3. Demant Ch., Streicher-Abel B. and Waszkewitz P., (1998), Industrielle Bildverarbeitung [Industrial Image Processing], Springer Verlag, Heidelberg.

4. Haberacker P., (1995), Praxis der digitalen Bildverarbeitung [Practice of Digital Image Processing]. 4th edition, Hanser, Munich.

5. Ifra, (2001), Closed loop printing quality control for coldset web offset (to be published), Darmstadt.

6. Jähne B., (1997), Digitale Bildverarbeitung [Digital Image Processing], Springer Verlag, Heidelberg.

7. Künzli H. et al. (1998), MiniTargets: A new dimension in print quality control, SPIE Conf. Proc., Vol. 3300, pp. 286-291.

8. Künzli H., (2000), How to convert RGB signals to calorimetric and densitometric values, Proceedings of SPIE, Vol. 3963, 70-76.

9. Künzli H., (2000), MiniTarget for Quality Control in Newspaper Printing, TAGA Proceedings, 509-520.

10. Mourad S. et al. (2001), Predicting Transmittance Spectra of Electrophotographic Color Prints, Proceeding of SPIE, Vol. 4300, 50-57.

11. Romano D., (1999), Recorder Spot Size and its Effect on Image Quality and Half-Tone Reproduction, 280-293.

12. Romano F. J., Romano R. M. (1998), Encyclopedia of Graphic Communications, GATF, Prentice Hall, London.

What is claimed is:

1. A test target for determining typographic parameters of a print, the test target comprising: a plurality of dot clusters, each dot cluster including a plurality of adjacent recorded dots printed on a printed copy in the form of an identified dot pattern.

2. A test target in accordance with claim 1, wherein one or more of said plurality of dot clusters is in one print color.

3. A test target in accordance with claim 1, wherein said plurality of dot clusters includes at least one single color dot cluster for each of a plurality of individual colors of the print.

4. A test target in accordance with claim 1, wherein the test target consists solely of said dot clusters.

5. A test target in accordance with claim 1, wherein none of said plurality of dot clusters is in dot closure with an adjacent dot cluster of said plurality of dot clusters.

6. A test target in accordance with claim 1, wherein said dot patterns of said dot clusters form a matrix with rows and columns fully occupied by the dot clusters as matrix elements.

7. A test target in accordance with claim 1, wherein the dot clusters form a matrix, in the rows of which the individual colors of the print are arranged one after another.

8. A test target in accordance with claim 1, wherein the dot clusters form a matrix, in the columns of which the individual colors of the print are arranged one after another.

9. A test target in accordance with claim 1, wherein the dot clusters are arranged in the form of a matrix, whose diagonals are formed by dot clusters of only one individual color of the print, wherein each individual color of the print forms at least one diagonal with preferably at least two dot clusters.

10. A process for determining typographic parameters, the process comprising:
forming a test target by printing a plurality of dot clusters, each dot cluster including a plurality of adjacent recorded dots printed on a printed copy in the form of a dot pattern;
automatically recognizing the test target;
measuring the test target; and
evaluating measurement values to determine typographic parameters including at least one of the area coverage, the full-tone density, the color value, shifting and doubling.

11. A process in accordance with claim 10, wherein said step of automatically recognizing the test target includes recognizing the test target as a test target by image analysis.

12. A process in accordance with claim 10, wherein the dot clusters of the test target are measured planimetrically.

13. A process in accordance with claim 10, wherein the diameter, size and shape including one or more of position angle a, ellipsoid parameter E and factor R of the dot clusters are determined.

14. A process in accordance with claim 10, wherein the typographic parameters determined are used to test and preferably to control and/or to regulate the printing process in a control and/or regulating unit.

15. A process for determining typographic parameters, the process comprising:
forming a test target by printing a plurality of dot clusters, each dot cluster including a plurality of adjacent recorded dots printed on a printed copy in the form of a dot pattern; and
measuring the test target.

16. A process in accordance with claim 15, wherein said step of measuring includes microscopically enlarging the test target and recording the enlarged image with a charge couple device (CCD) camera.

17. A process in accordance with claim 16, wherein said step of measuring further includes increasing the signal-to-noise ratio of the measurement by averaging over a plurality of consecutive printed dot patterns.

18. A process in accordance with claim 16, further comprising:
evaluating measurement values to determine typographic parameters including at least one of the area coverage, the full-tone density, the color value, shifting and doubling.

19. A process in accordance with claim 15, wherein further comprising recognizing the test target using image analysis.
